(19) United States
(12) Patent Application Publication
(10) Pub. No.: US 2013/0107365 A1
(43) Pub. Date: May 2, 2013

(54) ZOOM LENS SYSTEM

(71) Applicant: Hoya Corporation, Tokyo (JP)

(72) Inventor: Yasuo KANAZASHI, Tokyo (JP)

(73) Assignee: HOYA CORPORATION, Tokyo (JP)

(21) Appl. No.: 13/650,546

(22) Filed: Oct. 12, 2012

(30) Foreign Application Priority Data
Oct. 31, 2011 (JP) 2011-239181

(51) Int. Cl. G02B 27/64; G02B 15/14

(52) U.S. Cl. 359/557

(57) ABSTRACT

A zoom lens system includes first through fourth lens groups. The third lens group includes at least two positive single lens elements, wherein, with respect to the object side, one of a second or subsequently rearward positive single lens element thereof constitutes an image-shake correcting lens element. The following conditions (1) and (2) are satisfied:

0<De<15 (1), and

2.0<1/((1−G3Rmt)Fmt)<3.0 (2), wherein,

at the long focal length extremity when focused on an object at infinity, De designates the distance [mm] from the surface on the object side of the image-shake correcting lens element to the incident pupil, G3Rmt designates the lateral magnification of the image-shake correcting lens element, and Fmt designates the lateral magnification of a lens group immediately behind the image-shake correcting lens element.

### BACKGROUND OF THE INVENTION

1. Field of the Invention

The present invention relates to a zoom lens system provided with an optical image-shake correcting function (image-stabilizing function).

2. Description of Related Art

In recent years, it is typical for a zoom lens system to be utilized in the field of products such as photographic cameras, electronic still cameras and video cameras. Furthermore, the market has been increasingly demanding a higher optical quality, a high zoom ratio, and more compactness.

Many different arrangements having various refractive power distributions exist for zoom lens systems in accordance with their zoom ratio and use. A zoom lens system configured of four lens groups, i.e., a positive first lens group, a negative second lens group, a positive third lens group and a positive fourth lens group, in that order from the object side, is known in the art as a zoom lens system which is arranged to have a fast f-number with the aim to achieve a higher optical quality.

Furthermore, in such a zoom lens systems having four lens groups, there are zoom lens systems known in the art in which a so-called “optical image-shake correcting function” is provided that corrects image-shake by driving (moving) at least a portion of a lens group in directions orthogonal to the optical axis of the zoom lens system in accordance with the magnitude and direction of hand shake that is applied to the camera, to which the zoom lens system is mounted (Japanese Unexamined Patent Publication Nos. 2007-122019 and 2005-107280).

In Japanese Unexamined Patent Publication No. 2007-122019, aberration fluctuations are suppressed and the optical quality of the zoom lens system is improved by configuring the entire third lens group as an image-shake correcting lens group.

However, since the entire third lens group is used as an image-shake correcting lens group, the image-shake correcting lens group and the driving device (mechanical system) therefor becomes large and heavy, and hence, the entire zoom lens system also becomes large and heavy. In particular, in a zoom lens system having a positive lens group, a negative lens group, a positive lens group and a positive lens group, in that order from the object side, i.e., four lens groups, since there is a tendency for the third lens group (master lens group) to increase in size, this drawback (demerit) becomes more prominent.

In Japanese Unexamined Patent Publication No. 2005-107280, the image-shake correcting lens group and the driving device (mechanical system) therefor have been miniaturized and decreased in weight, and hence, the entire zoom lens system also has been miniaturized and decreased in weight, by configuring a portion (at least one lens element) of the third lens group as an image-shake correcting lens group.

However, since the lateral magnification of the image-shake correcting lens group is set inappropriately, when the image-shake correcting lens group is driven (moved/shifted) in directions that are orthogonal to the optical axis, a large amount of field curvature occurs, thereby deteriorating the optical quality of the lens system. Furthermore, the image-stabilizing sensitivity of the image-shake correcting lens group is too high, so that the mechanical positioning of the image-shake correcting lens group must be precisely carried out, which increases the cost and causes difficulties during assembly, and hence, the image-stabilizing control cannot be precisely carried out to favorable degree.

### SUMMARY OF THE INVENTION

The present invention has been devised in view of the aforementioned problems, and provides a zoom lens system in which the image-shake correcting lens group has been miniaturized and reduced in weight, the lateral magnification and image-stabilizing sensitivity of the image-shake correcting lens group are appropriately set, field curvature is suppressed during an image-shake correcting operation, and has a superior optical quality.

According to an aspect of the present invention, a zoom lens system is provided, including a positive first lens group, a negative second lens group, a positive third lens group and a fourth lens group, in that order from the object side. The third lens group includes at least two positive single lens elements, wherein, with respect to the object side, one of a second or subsequently rearward positive single lens element of the at least two positive single lens elements constitutes an image-shake correcting lens element which corrects an image-shake by moving in directions orthogonal to the optical axis to change an imaging position. The following conditions (1) and (2) are satisfied:

0<De<15 (1), and

2.0<1/((1−G3Rmt)Fmt)<3.0 (2), wherein

De designates the distance [mm] from the surface on the object side of the image-shake correcting lens element of the third lens group to the incident pupil, at the long focal length extremity when focused on an object at infinity; G3Rmt designates the lateral magnification of the image-shake correcting lens element of the third lens group, at the long focal length extremity when focused on an object at infinity, and Fmt designates the lateral magnification of a lens group immediately behind the image-shake correcting lens element, at the long focal length extremity when focused on an object at infinity.

In the zoom lens system according to the present invention, the fourth lens group can either have a positive refractive power or a negative refractive power.

The “lens group immediately behind the image-shake correcting lens element” refers to the lens group that is positioned immediately behind the image-shake correcting lens element with respect to the entire zoom lens system. Accordingly, in the case where the image-shake correcting lens element is provided at a position closest to the image side within the third lens group, the “lens group immediately behind the image-shake correcting lens element” refers to the “fourth lens group”. Furthermore, in the case where the image-shake correcting lens element is provided at a position other than a position closest to the image side within the third lens group, the “lens group immediately behind the image-shake correcting lens element” refers to the “lens group immediately behind the image-shake correcting lens element of the third lens group and the fourth lens group”.

It is desirable for the following condition (3) to be satisfied:

2.0<G3Rf/G3f<3.5 (3), wherein

G3Rf designates the focal length of the image-shake correcting lens element of the third lens group, and G3f designates the focal length of the third lens group.

It is desirable for the following condition (4) to be satisfied:

1.0<Ft/G3Rf<2.0 (4), wherein

Ft designates the focal length of the entire zoom lens system at the long focal length extremity, and G3Rf designates the focal length of the image-shake correcting lens element of the third lens group.

It is desirable for the following condition (5) to be satisfied:

3.0<1/((1−G3Rmw)Fmw)<5.0 (5), wherein

G3Rmw designates the lateral magnification of the image-shake correcting lens element of the third lens group, at the short focal length extremity when focused on an object at infinity, and Fmw designates the lateral magnification of a lens group immediately behind the image-shake correcting lens element, at the short focal length extremity when focused on an object at infinity.

It is desirable for the third lens group to include a positive single lens element, a negative cemented lens provided with a positive lens element and a negative lens element; and a positive single lens element, in that order from the object side, wherein the positive single lens element provided closest to the image side within the third lens group is the image-shake correcting lens element.

It is desirable for the following conditions (6) and (7) to be satisfied:

−0.5<G3Fmw<−0.15 (6), and

0.35<(R2+R1)/(R2−R1)<0.65 (7), wherein

G3Fmw designates the lateral magnification of the positive single lens element that is provided on the object side within the third lens group, at the short focal length extremity, R2 designates the radius of curvature of the surface on the image side of the positive single lens element on the object side within the third lens group, and R1 designates the radius of curvature of the surface on the object side of the positive single lens element on the object side within the third lens group.

It is desirable for the following condition (8) to be satisfied:

−1.5<G3Fmt<−0.4 (8), wherein

G3Fmt designates the lateral magnification of the positive single lens element that is provided on the object side within the third lens group, at the long focal length extremity.

It is desirable for the following condition (9) to be satisfied:

−0.25<φ/(n2−n1)<−0.05 (9), wherein

φ designates the combined refractive power of the cemented lens within the third lens group, n2 designates the refractive index at the d-line of the negative lens element provided in the cemented lens within the third lens group, and n1 designates the refractive index at the d-line of the positive lens element provided in the cemented lens within the third lens group.

In an embodiment, a zoom lens system is provided, including a positive first lens group, a negative second lens group, a positive third lens group and a fourth lens group, in that order from the object side, wherein the third lens group is divided into a positive front lens group and a positive rear lens group at a maximum air-distance therebetween, in that order from the object side. The rear lens group is an image-shake correcting lens group which corrects image-shake by moving in directions orthogonal to the optical axis, thereby changing the imaging position. The following conditions (1′) and (2′) are satisfied:

0<De′<15 (1′), and

2.0<1/((1−G3Rmt′)Fmt′)<3.0 (2′), wherein

De′ designates the distance [mm] from the surface on the object side of the image-shake correcting lens group of the third lens group to the incident pupil, at the long focal length extremity when focused on an object at infinity; G3Rmt′ designates the lateral magnification of the image-shake correcting lens group of the third lens group, at the long focal length extremity when focused on an object at infinity, and Fmt′ designates the lateral magnification of a lens group immediately behind the image-shake correcting lens group, at the long focal length extremity when focused on an object at infinity.

It is desirable for the image-shake correcting lens group of the third lens group to be a positive single lens element.

According to the present invention, a zoom lens system is achieved in which the image-shake correcting lens group has been miniaturized and reduced in weight, the lateral magnification and image-stabilizing sensitivity of the image-shake correcting lens group are appropriately set, field curvature is suppressed during an image-shake correcting operation, and has a superior optical quality.

The present disclosure relates to subject matter contained in Japanese Patent Application No. 2011-239181 (filed on Oct. 31, 2011) which is expressly incorporated herein in its entirety.

### BRIEF DESCRIPTION OF THE DRAWINGS

The present invention will be discussed below in detail with reference to the accompanying drawings, in which:

FIG. 1 shows a lens arrangement of a first numerical embodiment of a zoom lens system, according to the present invention, at the long focal length extremity when focused on an object at infinity;

FIGS. 2A, 2B, 2C and 2D show various aberrations that occurred in the lens arrangement shown in FIG. 1;

FIG. 3 shows a lens arrangement of the first numerical embodiment of the zoom lens system, according to the present invention, at the short focal length extremity when focused on an object at infinity;

FIGS. 4A, 4B, 4C and 4D show various aberrations that occurred in the lens arrangement shown in FIG. 3;

FIG. 5 shows a lens arrangement of a second numerical embodiment of a zoom lens system, according to the present invention, at the long focal length extremity when focused on an object at infinity;

FIGS. 6A, 6B, 6C and 6D show various aberrations that occurred in the lens arrangement shown in FIG. 5;

FIG. 7 shows a lens arrangement of the second numerical embodiment of the zoom lens system, according to the present invention, at the short focal length extremity when focused on an object at infinity;

FIGS. 8A, 8B, 8C and 8D show various aberrations that occurred in the lens arrangement shown in FIG. 7;

FIG. 9 shows a lens arrangement of a third numerical embodiment of a zoom lens system, according to the present invention, at the long focal length extremity when focused on an object at infinity;

FIGS. 10A, 10B, 10C and 10D show various aberrations that occurred in the lens arrangement shown in FIG. 9;

FIG. 11 shows a lens arrangement of the third numerical embodiment of the zoom lens system, according to the present invention, at the short focal length extremity when focused on an object at infinity;

FIGS. 12A, 12B, 12C and 12D show various aberrations that occurred in the lens arrangement shown in FIG. 11;

FIG. 13 shows a lens arrangement of a fourth numerical embodiment of a zoom lens system, according to the present invention, at the long focal length extremity when focused on an object at infinity;

FIGS. 14A, 14B, 14C and 14D show various aberrations that occurred in the lens arrangement shown in FIG. 13;

FIG. 15 shows a lens arrangement of the fourth numerical embodiment of the zoom lens system, according to the present invention, at the short focal length extremity when focused on an object at infinity;

FIGS. 16A, 16B, 16C and 16D show various aberrations that occurred in the lens arrangement shown in FIG. 15; and

FIG. 17 shows a zoom path of the zoom lens system according to the present invention.

### DESCRIPTION OF THE EMBODIMENTS

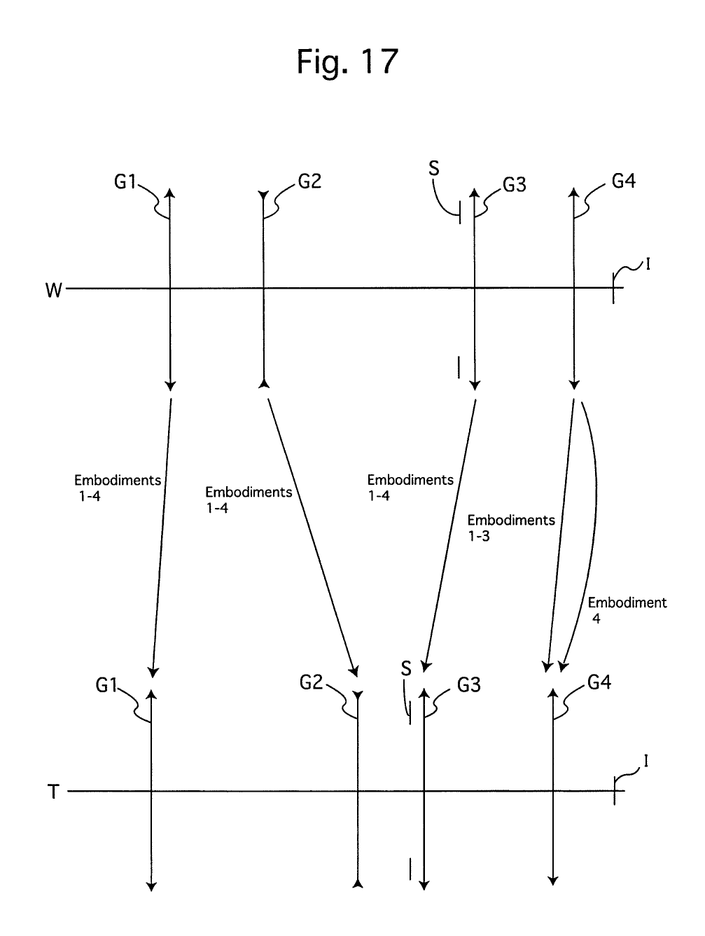

The zoom lens system according to the present invention, in each of the first through fourth numerical embodiments, is configured of a positive first lens group G1, a negative second lens group G2, a positive third lens group G3 and a positive fourth lens group G4, in that order from the object side, as shown in the zoom path of FIG. 17. The fourth lens group G4 does not necessarily need to have a positive refractive power; the fourth lens group G4 can alternatively have a negative refractive power. A diaphragm S which is provided in between the second lens group G2 and the third lens group G3 moves integrally with the third lens group G3 during a zooming operation. Focusing is carried out by advancing the fourth lens group G4 in the optical axis direction (e.g., by moving the fourth lens group G4 toward the object side). “I” designates the imaging plane.

The zoom lens system according to the present invention, upon zooming from the short focal length extremity (WIDE) to the long focal length extremity (TELE), moves each of the first through fourth lens groups G1 through G4 in the optical axis direction while increasing the distance between the first and second lens groups G1 and G2, decreasing the distance between the second and third lens groups G2 and G3, and increasing the distance between the third and fourth lens group G3 and G4 (or alternatively, the distance between the third and fourth lens group G3 and G4 remaining substantially the same).

More specifically, the first lens group G1, upon zooming from the short focal length extremity to the long focal length extremity, moves monotonically toward the object side in each of the first through fourth numerical embodiments. The second lens group G2, upon zooming from the short focal length extremity to the long focal length extremity, moves monotonically toward the image side in each of the first through fourth numerical embodiments. The third lens group G3, upon zooming from the short focal length extremity to the long focal length extremity, moves monotonically toward the object side in each of the first through fourth numerical embodiments. The fourth lens group G4, upon zooming from the short focal length extremity to the long focal length extremity, moves monotonically toward the object side in each of the first through third numerical embodiments; whereas in the fourth numerical embodiment, the fourth lens group G4 first moves toward the image side and thereafter moves back toward the object side until a position that is closer to the object side than when the fourth lens group G4 is positioned at the short focal length extremity (so that the fourth lens group G4 moves toward the object side overall).

In each of the first through fourth numerical embodiments, the first lens group G1 is configured of a cemented lens having a negative lens element 11 and a positive lens element 12, in that order from the object side.

In each of the first through third numerical embodiments, the second lens group G2 is configured of a negative lens element 21 and a cemented lens having a negative lens element 22 and a positive lens element 23, in that order from the object side.

In the fourth numerical embodiment, the second lens group G2 is configured of a negative lens element 24, a negative lens element 25, a positive lens element 26 and a negative lens element 27, in that order from the object side.

In each of the first through fourth numerical embodiments, the third lens group G3 is configured of a positive lens element (positive single lens element) 31, a negative cemented lens having a positive lens element 32 and a negative lens element 33; and a positive lens element (positive single lens element) 34, in that order from the object side. The positive lens element 31 is provided with an aspherical surface on each side thereof.

The positive lens element 34 is an image-shake correcting lens element (image-stabilizing lens element) which can change the imaging position (stabilize the object image) by moving in directions that are orthogonal to the optical axis.

In the first numerical embodiment, the fourth lens group G4 is configured of a cemented lens having a positive lens element 41 and a negative lens element 42 in that order from the object side.

In the second through fourth numerical embodiments, the fourth lens group G4 is configured of a positive lens element (positive single lens element) 43. The positive lens element 43 is provided with an aspherical surface on each side thereof.

An axial light bundle is incident on the third lens group G3 at a surface thereof that is closest to the object side in a state in which the light bundle is at a maximum “thickness” (light-bundle diameter) in which the outermost rays thereof are distant from the optical axis. Accordingly, out of the two positive single lens elements within the third lens group G3, if the positive single lens element (the positive single lens element that is positioned closest to the object side within the third lens group G3) 31 on the object side is used as an image-shake correcting lens element that is moved (driven) in directions orthogonal to the optical axis, occurrence of the spherical aberration increases, thereby deteriorating the optical quality.

Consequently, in each of the first through fourth numerical embodiments, out of the two positive single lens elements within the third lens group G3, by using the positive single lens element (the positive single lens element that is positioned closest to the image side within the third lens group G3) 34 on the image side as an image-shake correcting lens element, occurrence of spherical aberration can be suppressed, thereby preventing deterioration in the optical quality. Furthermore, the image-shake correcting lens element 34 and the mechanical driving system therefor, and hence the entire zoom lens system, can be miniaturized and reduced in weight.

The third lens group G3 is only required to include at least two positive single lens elements, and, for example, can include three or more positive single lens elements. In such an embodiment, out of the positive single lens elements within the third lens group G3, any of the positive single lens elements from the second positive single lens element rearwards from the object side can be used as the image-shake correcting lens element.

Condition (1) specifies the distance between the surface on the object side of the image-shake correcting lens element 34 within the third lens group G3 and the incident pupil at the long focal length extremity when focusing on an object at infinity. By satisfying condition (1), field curvature occurring during the movement of the image-shake correcting lens element 34 in directions orthogonal to the optical axis can be reduced, so that a superior optical quality can be obtained.

If the upper limit of condition (1) is exceeded, when the image-shake correcting lens element 34 is moved (shifted) in directions orthogonal to the optical axis, a large amount of positive field curvature occurs at image-plane coordinates that are opposite to the movement direction of the image-shake correcting lens element 34, thereby deteriorating the optical quality.

If the lower limit of condition (1) is exceeded, when the image-shake correcting lens element 34 is moved (shifted) in directions orthogonal to the optical axis, a large amount of negative field curvature occurs at image-plane coordinates that are opposite to the movement direction of the image-shake correcting lens element 34, thereby deteriorating the optical quality.

Condition (2) specifies the ratio of the lateral magnification of the image-shake correcting lens element 34 to that of the lens group immediately behind the image-shake correcting lens element 34 (i.e., the fourth lens group G4) when focusing on an object at infinity at the long focal length extremity. In other words, condition (2) specifies the image-stabilizing sensitivity at the long focal length extremity of the image-shake correcting lens element 34. By satisfying condition (2), the image-stabilizing sensitivity of the image-shake correcting lens element 34 can be appropriately set, a superior optical quality can be obtained during image-shake correction, and the image-stabilizing driving amount (shift amount/moving amount) of the image-shake correcting lens element 34 can be reduced so that the entire zoom lens system including an image-stabilizing driving mechanism therefor can be miniaturized.

If the lateral magnification of the image-shake correcting lens element 34 becomes large, the movement amount (shift amount) of the image-shake correcting lens element 34 for correcting deviations in the imaging position can be small, however, since the amount of aberration fluctuations increase, the optical quality deteriorates. Furthermore, if the movement amount (shift amount) of the image-shake correcting lens element 34 is small so that the image-stabilizing sensitivity becomes high, the mechanical positioning precision for the image-shake correcting lens element 34 cannot keep up with such a high image-stabilizing sensitivity, thereby causing a deterioration in the optical quality. Conversely, if the lateral magnification of the image-shake correcting lens element 34 becomes small, the deterioration of the optical quality can be reduced to a small amount, however, since the movement amount (shift amount) of the image-shake correcting lens element 34 becomes large, the entire zoom lens system including the image-stabilizing driving mechanism therefor becomes large. Accordingly, it is extremely important to attain a balance between the lateral magnification of the image-shake correcting lens element 34 and the amount of aberration fluctuations.

If the upper limit of condition (2) is exceeded, the image-stabilizing sensitivity of the image-shake correcting lens element 34 becomes too low, so that since the image-stabilizing movement amount (shift amount) for obtaining a required image-shake correction amount becomes large, the entire zoom lens system including the image-stabilizing driving mechanism therefor becomes large.

If the lower limit of condition (2) is exceeded, when the image-shake correcting lens element 34 is moved (driven/shifted) in directions orthogonal to the optical axis, a large amount of field curvature occurs, thereby deteriorating the optical quality. Furthermore, the image-stabilizing sensitivity of the image-shake correcting lens element 34 becomes too high, so that the mechanical positioning of the image-shake correcting lens element 34 must be carried out with high precision, thereby increasing costs, causing difficulties in the assembly process, and the control process for image stabilization cannot be carried out with precision.

In the illustrated embodiments, it is also possible to divide the third lens group G3 into a positive front lens group (lens elements 31, 32 and 33) and a positive rear lens group (image-shake correcting lens element 34) at a maximum air-distance therebetween.

Conditions (1′) and (2′) assume an arrangement in which the third lens group G3 is divided into the front lens group and the rear lens group, as mentioned above, and are fundamentally the same as conditions (1) and (2).

By satisfying condition (1′), the amount of field curvature that occurs when the rear lens group (image-shake correcting lens element 34) is moved (driven/shifted) in directions orthogonal to the optical axis can be reduced to a small amount, so that a superior optical quality can be obtained.

By satisfying condition (2′), the image-stabilizing sensitivity of the rear lens group (image-shake correcting lens element 34) can be appropriately set, so that a superior optical quality can be obtained during image-shake correction, and the image-stabilizing driving amount (shift amount/moving amount) of the rear lens group (image-shake correcting lens element 34) can be reduced so that the entire zoom lens system including an image-stabilizing driving mechanism therefor can be miniaturized.

Condition (3) specifies the ratio of the focal length of the image-shake correcting lens element 34 to the focal length of the third lens group G3. By satisfying condition (3), a superior optical quality can be obtained during image-shake correction, and the image-stabilizing driving amount (shift amount/moving amount) of the image-shake correcting lens element 34 can be reduced so that the entire zoom lens system including an image-stabilizing driving mechanism therefor can be miniaturized.

If the upper limit of condition (3) is exceeded, since the image-stabilizing driving amount (shift amount/moving amount) required for the image-shake correcting lens element 34 becomes large, the entire zoom lens system including the image-stabilizing driving mechanism therefor becomes enlarged. Furthermore, a large amount of aberrations occur, thereby deteriorating the optical quality.

If the lower limit of condition (3) is exceeded, deterioration of the optical quality during the movement of the image-shake correcting lens element 34 in directions orthogonal to the optical axis increases.

Condition (4) specifies the ratio of the focal length of the entire zoom lens system at the long focal length extremity to the focal length of the image-shake correcting lens element 34. By satisfying condition (4), the image-stabilizing driving amount (shift amount/moving amount) of the image-shake correcting lens element 34 can be appropriately set, a superior optical quality can be obtained during image-shake correction, and the control process for image stabilization can be precisely carried out, so that the entire zoom lens system including an image-stabilizing driving mechanism therefor can be miniaturized.

If the upper limit of condition (4) is exceeded, the image-stabilizing driving amount (shift amount/moving amount) of the image-shake correcting lens element 34 necessary for obtaining a desired image-shake correcting amount (imaging position correction amount) becomes too small, so that the control process for image stabilization cannot be precisely carried out. Furthermore, deterioration of the optical quality also increases during image-shake correction.

If the lower limit of condition (4) is exceeded, since the image-stabilizing driving amount (shift amount/moving amount) required for the image-shake correcting lens element 34 becomes large, the entire zoom lens system including an image-stabilizing driving mechanism therefor becomes enlarged.

Condition (5) specifies the ratio of the lateral magnification of the image-shake correcting lens element 34 to that of the lens group immediately behind the image-shake correcting lens element 34 (e.g., the fourth lens group G4 in the case of the illustrated embodiments) when focusing on an object at infinity at the short focal length extremity. In other words, condition (5) specifies the image-stabilizing sensitivity at the short focal length extremity of the image-shake correcting lens element 34. By satisfying condition (5), the image-stabilizing sensitivity of the image-shake correcting lens element 34 can be appropriately set, a superior optical quality can be obtained during image-shake correction, and the image-stabilizing driving amount (shift amount/moving amount) of the image-shake correcting lens element 34 can be reduced so that the entire zoom lens system including an image-stabilizing driving mechanism therefor can be miniaturized.

If the upper limit of condition (5) is exceeded, the image-stabilizing sensitivity of the image-shake correcting lens element 34 becomes too low, so that since the image-stabilizing movement amount (shift amount) for obtaining a required image-shake correction amount becomes large, the entire zoom lens system including the image-stabilizing driving mechanism therefor becomes large.

If the lower limit of condition (5) is exceeded, when the image-shake correcting lens element 34 is moved (driven/shifted) in directions orthogonal to the optical axis, a large amount of field curvature occurs, thereby deteriorating the optical quality. Furthermore, the image-stabilizing sensitivity of the image-shake correcting lens element 34 becomes too high, so that the mechanical positioning of the image-shake correcting lens element 34 must be carried out with high precision, thereby increasing costs and causing difficulties in the assembly process. If the mechanical positioning precision of the image-shake correcting lens element 34 becomes excessively low, the control process for image stabilization cannot be carried out with precision.

In the zoom lens system according to the present invention, in each of the first through fourth numerical embodiments, the third lens group G3 is configured of a positive lens element (positive single lens element) 31, a negative cemented lens having a positive lens element 32 and a negative lens element 33; and a positive lens element (positive single lens element) 34, in that order from the object side, in which the positive lens element 34 provided on the image side constitutes the image-shake correcting lens element 34.

Conditions (6) through (9) assume the third lens group G3 to have the above-described lens arrangement.

Condition (6) specifies the lateral magnification of the positive single lens element 31 that is provided on the object side within the third lens group G3 when focusing on an object at infinity at the short focal length extremity. By satisfying condition (6), the occurrence of spherical aberrations can be suppressed, thereby obtaining a superior optical quality, and a favorable balance can be achieved with respect to the abaxial optical quality.

If the upper limit of condition (6) is exceeded, spherical aberration increases in the positive direction, thereby deteriorating the optical quality. Furthermore, the balance with respect to the abaxial optical quality is also lost.

If the lower limit of condition (6) is exceeded, spherical aberration increases in the negative direction, thereby deteriorating the optical quality. Furthermore, the balance with respect to the abaxial optical quality is also lost.

Condition (7) specifies the shape factor of the positive single lens element 31 that is provided on the object side within the third lens group G3. Since the axial light bundle incident on the third lens group G3 at a surface thereof that is closest to the object side is in a state in which the light bundle is at a maximum “thickness” (light-bundle diameter), by appropriately setting the shape factor of the positive single lens element 31, spherical aberration can be suppressed and a superior optical quality can be obtained, and furthermore, a favorable balance with respect to the abaxial optical quality can be attained.

If the upper limit of condition (7) is exceeded, although the amount of spherical aberration that occurs is reduced, the balance between the spherical aberrations of the positive lens element 31 and that of the lens group immediately behind the positive lens element 31 (i.e., the lens elements 32, 33 and 34 that are provided within the third lens group G3) increases in the negative direction, thereby deteriorating the optical quality. Furthermore, the balance with respect to the abaxial optical quality is also lost.

If the lower limit of condition (7) is exceeded, spherical aberration in the positive direction increases, thereby deteriorating the optical quality. Furthermore, the balance with respect to the abaxial optical quality is also lost.

Condition (8) specifies the lateral magnification of the positive single lens element 31 provided on the object side within the third lens group G3 when focusing on an object at infinity at the long focal length extremity. By satisfying condition (8), a superior optical quality can be achieved while suppressing the occurrence of spherical aberration, and a favorable balance with respect to the abaxial optical quality can also be achieved.

If the upper limit of condition (8) is exceeded, spherical aberration increases in the positive direction, thereby deteriorating the optical quality. Furthermore, the balance with respect to the abaxial optical quality is also lost.

If the lower limit of condition (8) is exceeded, spherical aberration increases in the negative direction, thereby deteriorating the optical quality. Furthermore, the balance with respect to the abaxial optical quality is also lost.

Condition (9) specifies the ratio of the combined refractive power of the cemented lens provided within the third lens group G3 to the difference of the refractive index at the d-line between the positive lens element 32 and the negative lens element 33 of this cemented lens. By satisfying condition (9), the spherical aberration at the bonding surface caused by the combined refractive power of the cemented lens provided within the third lens group G3 can be appropriately corrected and a superior optical quality can be attained.

If the upper limit of condition (9) is exceeded, correction of the spherical aberration at the bonding surface caused by the combined refractive power of the cemented lens provided within the third lens group G3 becomes insufficient, thereby deteriorating the optical quality. Furthermore, since the Petzval sum reduces greatly in the negative direction, the field curvature increases, and the optical quality likewise deteriorates.

If the lower limit of condition (9) is exceeded, correction of the spherical aberration at the bonding surface caused by the combined refractive power of the cemented lens provided within the third lens group G3 becomes excessive, thereby deteriorating the optical quality.

### EMBODIMENTS

Specific numerical embodiments will be herein discussed. In the aberration diagrams and the tables, the d-line, g-line, C-line, F-line and e-line show aberrations at their respective wave-lengths; S designates the sagittal image, M designates the meridional image, FNO. designates the f-number, f designates the focal length of the entire optical system, W designates the half angle of view (°), Y designates the image height, fB designates the backfocus, L designates the overall length of the lens system, r designates the radius of curvature, d designates the lens thickness or distance between lenses, N(d) designates the refractive index at the d-line, and νd designates the Abbe number with respect to the d-line. The unit used for the various lengths is defined in millimeters (mm). The values for the f-number, the focal length, the half angle-of-view, the image height, the backfocus, the overall length of the lens system, and the distance between lenses (which changes during zooming) are shown in the following order: short focal length extremity, intermediate focal length, and long focal length extremity.

An aspherical surface which is rotationally symmetrical about the optical axis is defined as:

x=cy²/(1+[1−{1+K}c²y²]^{1/2})+A4y⁴+A6y⁶+A8y⁸+A10y¹⁰+A12y¹²

wherein ‘x’ designates a distance from a tangent plane of the aspherical vertex, ‘c’ designates the curvature (l/r) of the aspherical vertex, ‘y’ designates the distance from the optical axis, ‘K’ designates the conic coefficient, A4 designates a fourth-order aspherical coefficient, A6 designates a sixth-order aspherical coefficient, A8 designates an eighth-order aspherical coefficient, A10 designates a tenth-order aspherical coefficient, A12 designates a twelfth-order aspherical coefficient, and ‘x’ designates the amount of sag.

### Numerical Embodiment 1

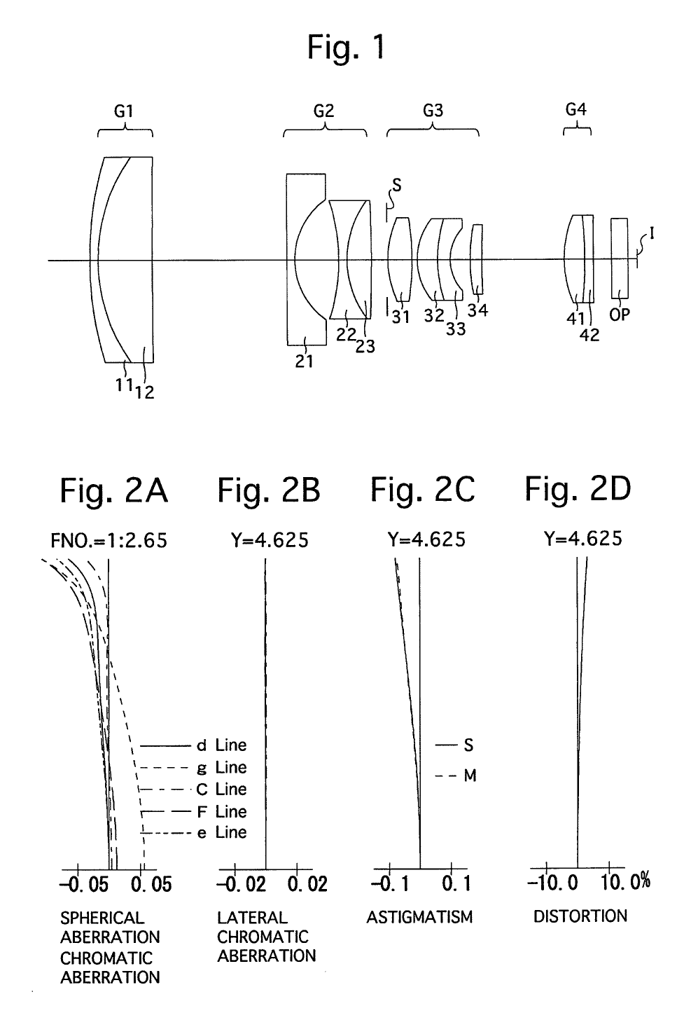

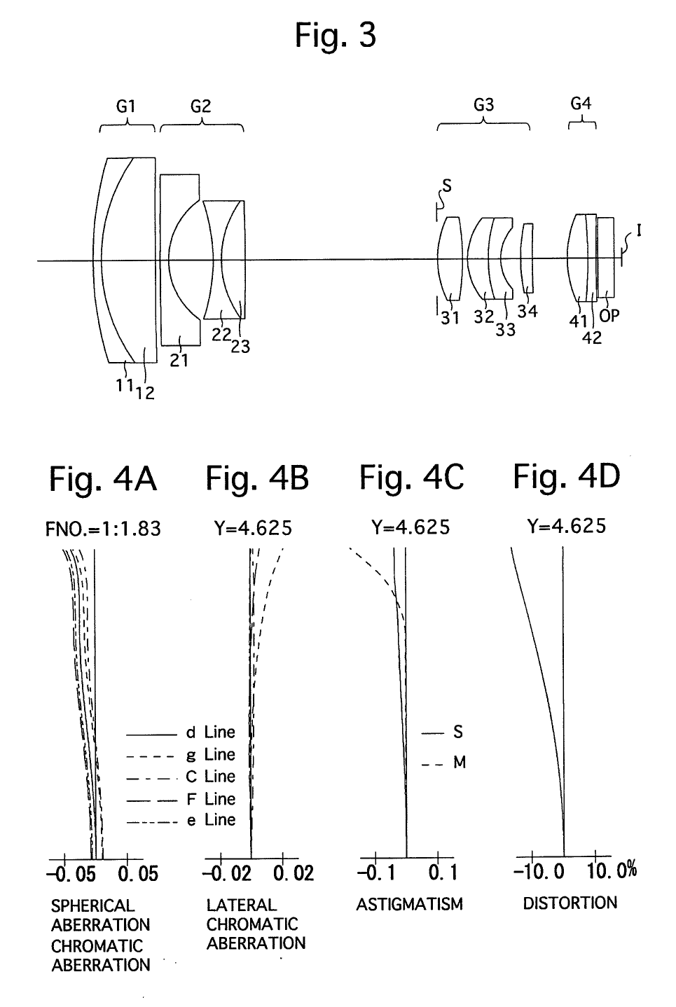

FIGS. 1 through 4D and Tables 1 through 4 show a first numerical embodiment of a zoom lens system according to the present invention. FIG. 1 shows a lens arrangement of the first numerical embodiment of the zoom lens system at the long focal length extremity when focused on an object at infinity. FIGS. 2A, 2B, 2C and 2D show various aberrations that occurred in the lens arrangement shown in FIG. 1. FIG. 3 shows a lens arrangement of the first numerical embodiment of the zoom lens system at the short focal length extremity when focused on an object at infinity. FIGS. 4A, 4B, 4C and 4D show various aberrations that occurred in the lens arrangement shown in FIG. 3. Table 1 shows the lens surface data, Table 2 shows various zoom lens system data, Table 3 shows the aspherical surface data, and Table 4 shows the lens group data of the zoom lens system according to the first numerical embodiment.

The zoom lens system of the first numerical embodiment is configured of a positive first lens group G1, a negative second lens group G2, a positive third lens group G3 and a positive fourth lens group G4, in that order from the object side. A diaphragm S that is provided in between the second lens group G2 and the third lens group G3 moves integrally with the third lens group G3 in the optical axis direction. An optical filter OP is disposed behind the fourth lens group G4 (between the fourth lens group G4 and the imaging plane I).

The first lens group G1 is configured of a cemented lens having a negative meniscus lens element 11 having a convex surface on the object side and a positive meniscus lens element 12 having a convex surface on the object side, in that order from the object side.

The second lens group G2 is configured of a negative meniscus lens element 21 having a convex surface on the object side, and a cemented lens having a biconcave negative lens element 22 and a biconvex positive lens element 23, in that order from the object side.

The third lens group G3 is configured of a biconvex positive lens element (positive single lens element) 31, a negative cemented lens having a positive meniscus lens element 32 having a convex surface on the object side and a negative meniscus lens element 33 having a convex surface on the object side; and a positive meniscus lens element (positive single lens element) 34 having a convex surface on the object side, in that order from the object side. The biconvex positive lens element 31 is provided with an aspherical surface on each side thereof.

The positive meniscus lens element 34 is an image-shake correcting lens element (image-stabilizing lens element) which corrects image-shake by moving in directions orthogonal to the optical axis to thereby change the imaging position.

The fourth lens group G4 is a cemented lens having a biconvex positive lens element 41 and a biconcave negative lens element 42, in that order from the object side.

TABLE 1
SURFACE DATA

| Surf. No. | r | d | Nd | νd |
|---|---|---|---|---|
| 1 | 43.396 | 1.000 | 1.64769 | 33.8 |
| 2 | 21.648 | 6.500 | 1.73000 | 64.5 |
| 3 | 854.098 | d3 | | |
| 4 | 872.623 | 1.000 | 1.74000 | 46.6 |
| 5 | 8.919 | 5.405 | | |
| 6 | −22.722 | 1.000 | 1.58000 | 46.8 |
| 7 | 11.780 | 3.000 | 1.81000 | 27.8 |
| 8 | −212.731 | d8 | | |
| 9(Diaphragm) | ∞ | 0.100 | | |
| 10* | 11.284 | 3.000 | 1.61881 | 63.8 |
| 11* | −29.454 | 0.619 | | |
| 12 | 7.829 | 2.500 | 1.62000 | 38.0 |
| 13 | 16.686 | 1.500 | 2.01000 | 19.2 |
| 14 | 5.683 | 2.397 | | |
| 15 | 21.054 | 1.400 | 1.80420 | 46.5 |
| 16 | 84.858 | d16 | | |
| 17 | 13.506 | 2.500 | 1.58000 | 59.8 |
| 18 | −57.803 | 1.000 | 1.81000 | 47.4 |
| 19 | 234.896 | d19 | | |
| 20 | ∞ | 2.000 | 1.51680 | 64.2 |
| 21 | ∞ | — | | |

The asterisk (*) designates an aspherical surface which is rotationally symmetrical with respect to the optical axis.

TABLE 2
ZOOM LENS SYSTEM DATA
Zoom Ratio 3.92

| | Short Focal Length | Intermediate | Long Focal Length |
|---|---|---|---|
| | Extremity | Focal Length | Extremity |
| FNO. | 1.8 | 2.5 | 2.7 |
| f | 6.18 | 11.43 | 24.22 |
| W | 41.8 | 21.5 | 10.5 |
| Y | 4.62 | 4.62 | 4.62 |
| fB | 0.50 | 0.50 | 0.50 |
| L | 64.12 | 64.51 | 65.94 |
| d3 | 0.598 | 10.009 | 16.315 |
| d8 | 23.326 | 12.239 | 1.919 |
| d16 | 4.176 | 5.207 | 9.866 |
| d19 | 0.602 | 1.637 | 2.421 |

TABLE 3
Aspherical Surface Data (the aspherical surface
coefficients not indicated are zero (0.00)):

| Surf. No. | K | A4 | A6 | A8 |
|---|---|---|---|---|
| 10 | −0.084 | −0.8275E−04 | −0.2109E−06 | −0.2226E−07 |
| 11 | 0.000 | 0.4831E−04 | 0.1240E−06 | −0.2802E−07 |

TABLE 4
LENS GROUP DATA

| Lens Group | 1^{st} Surf. | Focal Length |
|---|---|---|
| 1 | 1 | 55.85 |
| 2 | 4 | −12.06 |
| 3 | 10 | 13.33 |
| 4 | 17 | 27.71 |

### Numerical Embodiment 2

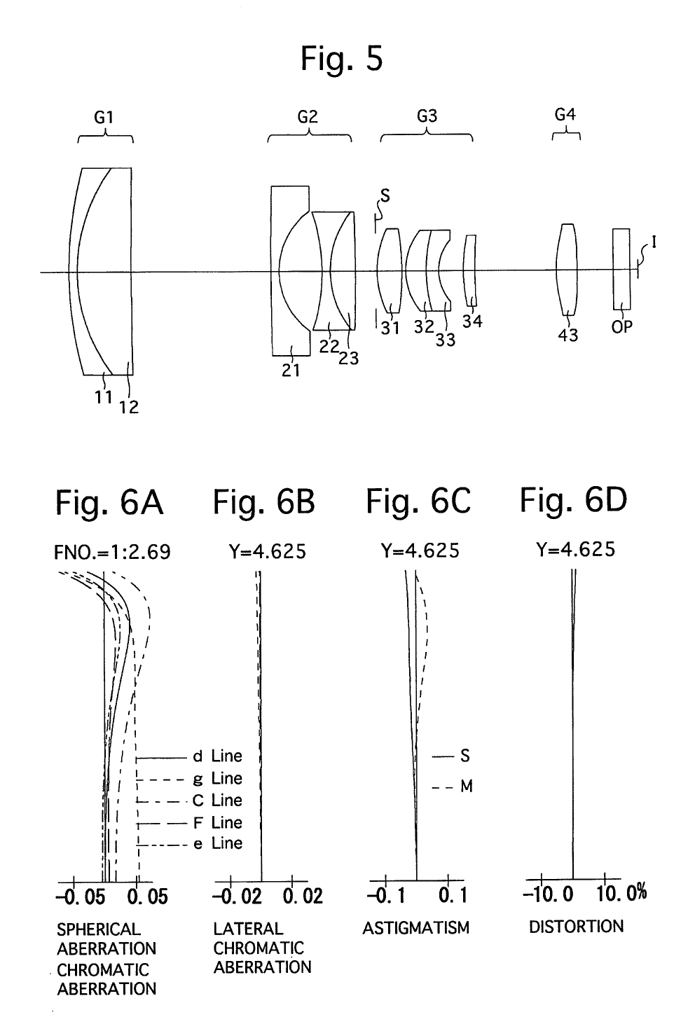

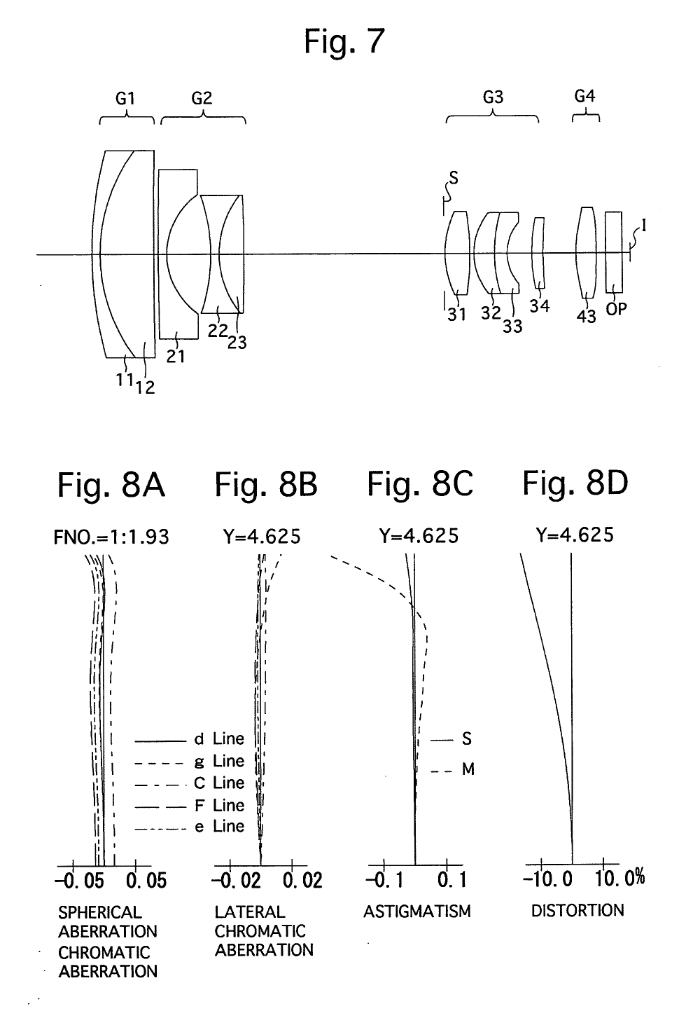

FIGS. 5 through 8D and Tables 5 through 8 show a second numerical embodiment of a zoom lens system according to the present invention. FIG. 5 shows a lens arrangement of the second numerical embodiment of the zoom lens system at the long focal length extremity when focused on an object at infinity. FIGS. 6A, 6B, 6C and 6D show various aberrations that occurred in the lens arrangement shown in FIG. 5. FIG. 7 shows a lens arrangement of the second numerical embodiment of the zoom lens system at the short focal length extremity when focused on an object at infinity. FIGS. 8A, 8B, 8C and 8D show various aberrations that occurred in the lens arrangement shown in FIG. 7. Table 5 shows the lens surface data, Table 6 shows various zoom lens system data, Table 7 shows the aspherical surface data, and Table 8 shows the lens group data of the zoom lens system according to the second numerical embodiment.

The lens arrangement of the second numerical embodiment is the same as that of the first numerical embodiment except for the following feature:

(1) The fourth lens group G4 is configured of a biconvex positive single lens element 43. This biconvex positive single lens element 43 is provided with an aspherical surface on each side thereof.

TABLE 5
SURFACE DATA

| Surf. No. | r | d | N(d) | νd |
|---|---|---|---|---|
| 1 | 46.872 | 1.000 | 1.64769 | 33.8 |
| 2 | 20.841 | 6.500 | 1.72916 | 54.7 |
| 3 | 949.720 | d3 | | |
| 4 | 571.285 | 1.000 | 1.72916 | 54.7 |
| 5 | 8.946 | 5.284 | | |
| 6 | −22.119 | 1.000 | 1.59270 | 35.5 |
| 7 | 11.603 | 3.000 | 1.80518 | 25.5 |
| 8 | −192.682 | d8 | | |
| 9(Diaphragm) | ∞ | 0.100 | | |
| 10* | 11.167 | 3.000 | 1.61881 | 63.8 |
| 11* | −30.372 | 0.462 | | |
| 12 | 7.776 | 2.500 | 1.61800 | 63.4 |
| 13 | 18.407 | 1.500 | 2.00069 | 25.5 |
| 14 | 5.672 | 3.010 | | |
| 15 | 21.649 | 1.400 | 1.80420 | 46.5 |
| 16 | 61.813 | d16 | | |
| 17* | 14.561 | 2.500 | 1.54358 | 55.7 |
| 18* | −318.960 | d18 | | |
| 19 | ∞ | 2.000 | 1.51680 | 64.2 |
| 20 | ∞ | — | | |

The asterisk (*) designates an aspherical surface which is rotationally symmetrical with respect to the optical axis.

TABLE 6
ZOOM LENS SYSTEM DATA
Zoom Ratio 3.96

| | Short Focal Length | Intermediate | Long Focal Length |
|---|---|---|---|
| | Extremity | Focal Length | Extremity |
| FNO. | 1.9 | 2.5 | 2.7 |
| f | 6.23 | 11.65 | 24.67 |
| W | 41.6 | 21.4 | 10.5 |
| Y | 4.62 | 4.62 | 4.62 |
| fB | 0.50 | 0.50 | 0.50 |
| L | 65.41 | 65.40 | 68.93 |
| d3 | 0.538 | 10.216 | 16.964 |
| d8 | 24.494 | 12.401 | 2.558 |
| d16 | 3.988 | 4.611 | 9.856 |
| d18 | 1.632 | 3.418 | 4.801 |

TABLE 7
Aspherical Surface Data (the aspherical surface
coefficients not indicated are zero (0.00)):

| Surf. No. | K | A4 | A6 | A8 | A10 |
|---|---|---|---|---|---|
| 10 | −0.089 | −0.8159E−04 | −0.1912E−06 | −0.2336E−07 | |
| 11 | 0.000 | 0.4891E−04 | 0.8330E−07 | −0.2924E−07 | |
| 17 | 0.000 | −0.2235E−03 | −0.6484E−05 | 0.8419E−07 | −0.3262E−10 |
| 18 | 0.000 | −0.3264E−03 | −0.4659E−05 | 0.4986E−07 | 0.4967E−09 |

TABLE 8
LENS GROUP DATA

| Lens Group | 1^{st} Surf. | Focal Length |
|---|---|---|
| 1 | 1 | 58.88 |
| 2 | 4 | −11.90 |
| 3 | 10 | 13.95 |
| 4 | 17 | 25.69 |

### Numerical Embodiment 3

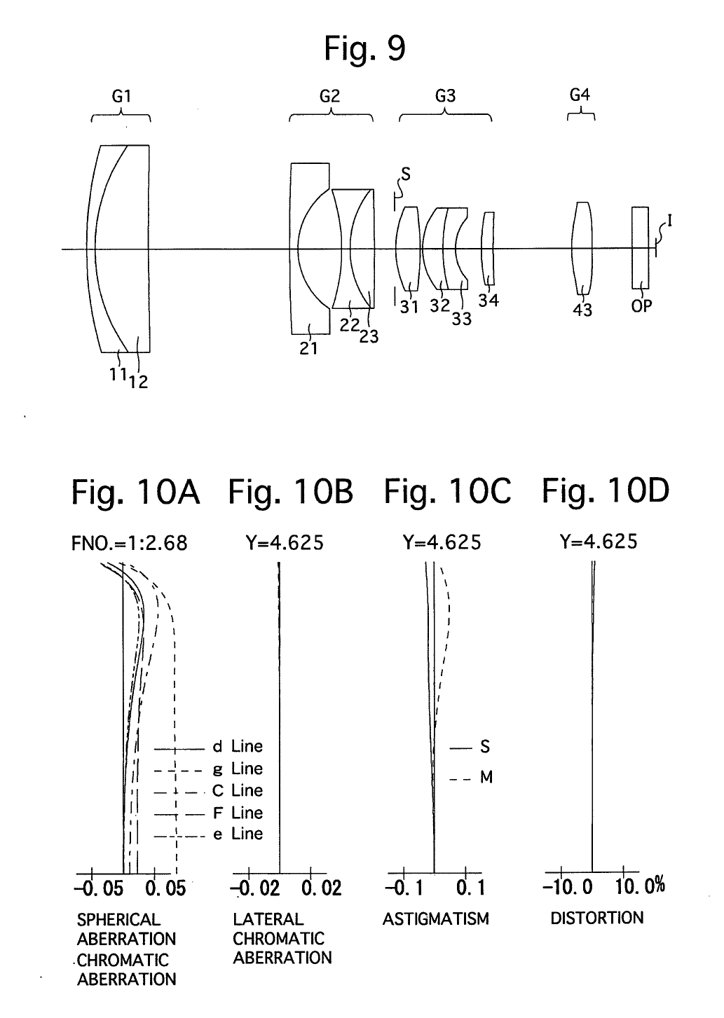

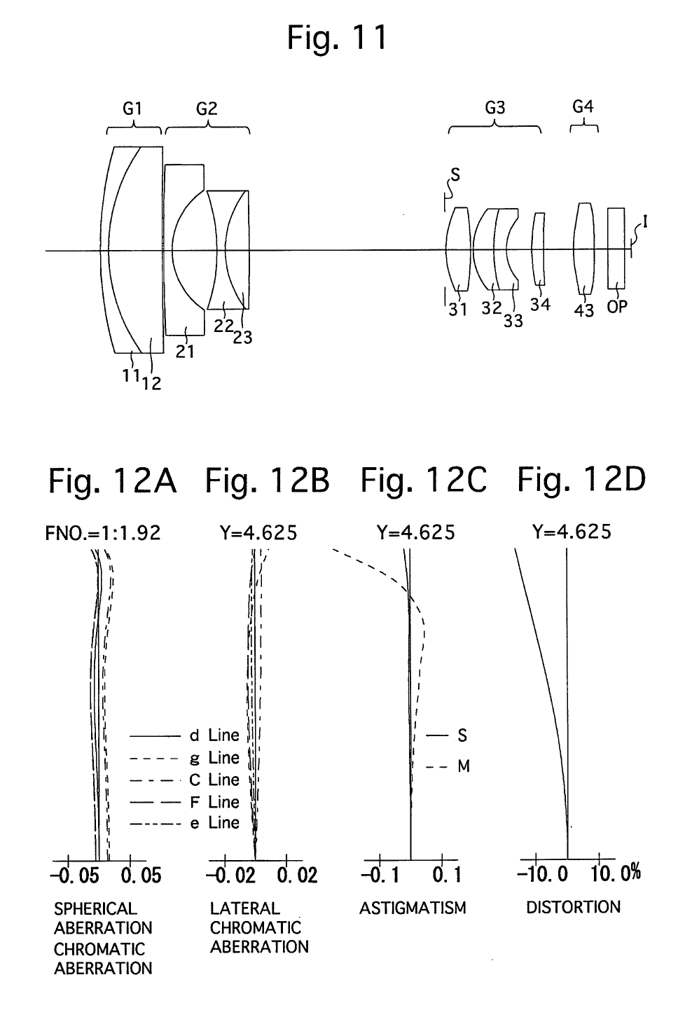

FIGS. 9 through 12D and Tables 9 through 12 show a third numerical embodiment of a zoom lens system according to the present invention. FIG. 9 shows a lens arrangement of the third numerical embodiment of the zoom lens system at the long focal length extremity when focused on an object at infinity. FIGS. 10A, 10B, 10C and 10D show various aberrations that occurred in the lens arrangement shown in FIG. 9. FIG. 11 shows a lens arrangement of the third numerical embodiment of the zoom lens system at the short focal length extremity when focused on an object at infinity. FIGS. 12A, 12B, 12C and 12D show various aberrations that occurred in the lens arrangement shown in FIG. 11. Table 9 shows the lens surface data, Table 10 shows various zoom lens system data, Table 11 shows the aspherical surface data, and Table 12 shows the lens group data of the zoom lens system according to the third numerical embodiment.

The lens arrangement of the third numerical embodiment is the same as that of the second numerical embodiment.

TABLE 9
SURFACE DATA

| Surf. No. | r | d | N(d) | νd |
|---|---|---|---|---|
| 1 | 45.964 | 1.000 | 1.64769 | 33.8 |
| 2 | 21.568 | 6.500 | 1.72916 | 54.7 |
| 3 | 716.971 | d3 | | |
| 4 | 242.699 | 1.000 | 1.72916 | 54.7 |
| 5 | 8.861 | 5.358 | | |
| 6 | −22.380 | 1.000 | 1.59270 | 35.5 |
| 7 | 11.422 | 3.000 | 1.80518 | 25.5 |
| 8 | −321.778 | d8 | | |
| 9(Diaphragm) | ∞ | 0.100 | | |
| 10* | 11.026 | 3.000 | 1.61881 | 63.8 |
| 11* | −32.157 | 0.307 | | |
| 12 | 7.745 | 2.500 | 1.61800 | 63.4 |
| 13 | 18.948 | 1.500 | 2.00069 | 25.5 |
| 14 | 5.668 | 3.108 | | |
| 15 | 21.673 | 1.400 | 1.80420 | 46.5 |
| 16 | 73.047 | d16 | | |
| 17* | 15.271 | 2.500 | 1.54358 | 55.7 |
| 18* | −199.252 | d18 | | |
| 19 | ∞ | 2.000 | 1.51680 | 64.2 |
| 20 | ∞ | — | | |

The asterisk (*) designates an aspherical surface which is rotationally symmetrical with respect to the optical axis.

TABLE 10
ZOOM LENS SYSTEM DATA
Zoom Ratio 3.96

| | Short Focal Length | Intermediate | Long Focal Length |
|---|---|---|---|
| | Extremity | Focal Length | Extremity |
| FNO. | 1.9 | 2.5 | 2.7 |
| f | 6.20 | 11.61 | 24.55 |
| W | 41.7 | 21.5 | 10.6 |
| Y | 4.62 | 4.62 | 4.62 |
| fB | 0.50 | 0.50 | 0.50 |
| L | 64.50 | 65.40 | 69.17 |
| d3 | 0.157 | 10.200 | 17.081 |
| d8 | 23.836 | 12.277 | 2.518 |
| d16 | 3.581 | 4.340 | 9.393 |
| d18 | 2.150 | 3.814 | 5.400 |

TABLE 11
Aspherical Surface Data (the aspherical surface
coefficients not indicated are zero (0.00)):

| Surf. No. | K | A4 | A6 | A8 | A10 |
|---|---|---|---|---|---|
| 10 | −0.068 | −0.7916E−04 | −0.2220E−06 | −0.2827E−07 | |
| 11 | 0.000 | 0.5255E−04 | 0.7978E−08 | −0.3308E−07 | |
| 17 | 0.000 | −0.2285E−03 | −0.6377E−05 | 0.8554E−07 | −0.5555E−10 |
| 18 | 0.000 | −0.3171E−03 | −0.4685E−05 | 0.4823E−07 | 0.4354E−09 |

TABLE 12
LENS GROUP DATA

| Lens Group | 1^{st} Surf. | Focal Length |
|---|---|---|
| 1 | 1 | 59.18 |
| 2 | 4 | −11.78 |
| 3 | 10 | 14.02 |
| 4 | 17 | 26.20 |

### Numerical Embodiment 4

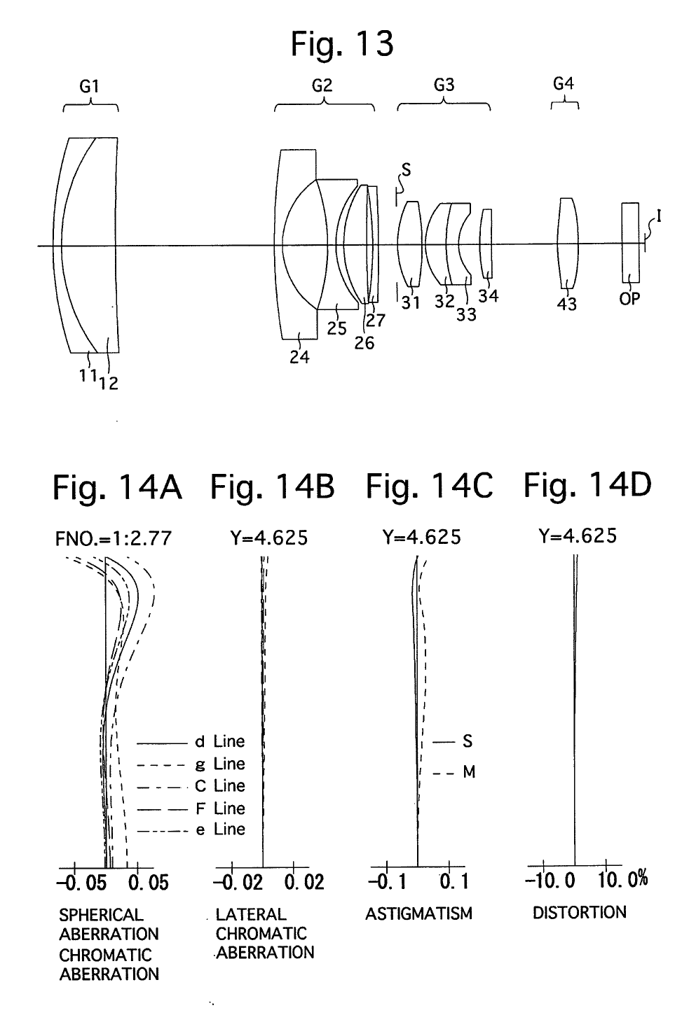

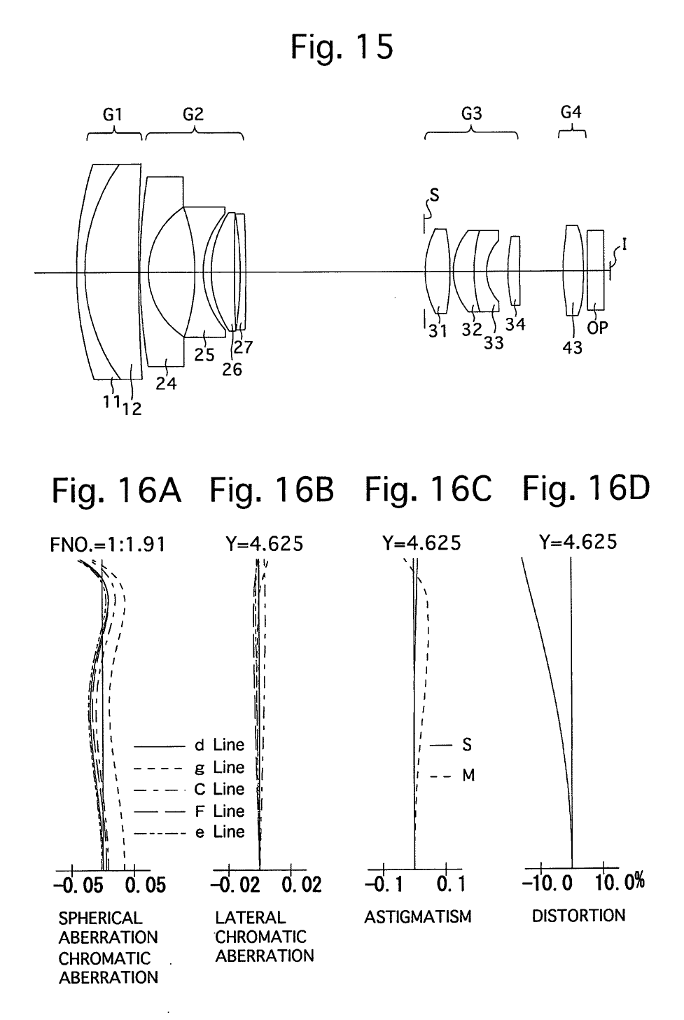

FIGS. 13 through 16D and Tables 13 through 16 show a fourth numerical embodiment of a zoom lens system according to the present invention. FIG. 13 shows a lens arrangement of the fourth numerical embodiment of the zoom lens system at the long focal length extremity when focused on an object at infinity. FIGS. 14A, 14B, 14C and 14D show various aberrations that occurred in the lens arrangement shown in FIG. 13. FIG. 15 shows a lens arrangement of the fourth numerical embodiment of the zoom lens system at the short focal length extremity when focused on an object at infinity. FIGS. 16A, 16B, 16C and 16D show various aberrations that occurred in the lens arrangement shown in FIG. 15. Table 13 shows the lens surface data, Table 14 shows various zoom lens system data, Table 15 shows the aspherical surface data, and Table 16 shows the lens group data of the zoom lens system according to the fourth numerical embodiment.

The lens arrangement of the fourth numerical embodiment is the same as that of the second and third numerical embodiments except for the following feature:

(1) The second lens group G2 is configured of a negative meniscus lens element 24 having a convex surface on the object side, a biconcave negative lens element 25, a positive meniscus lens element 26 having a convex surface on the object side, and a negative meniscus lens element 27 having a convex surface on the image side, in that order from the object side.

TABLE 13
SURFACE DATA

| Surf. No. | r | d | N(d) | νd |
|---|---|---|---|---|
| 1 | 42.898 | 1.000 | 1.65000 | 32.4 |
| 2 | 22.283 | 6.500 | 1.72916 | 54.7 |
| 3 | 247.701 | d3 | | |
| 4 | 73.623 | 1.000 | 1.64000 | 44.8 |
| 5 | 9.618 | 5.573 | | |
| 6 | −24.004 | 1.000 | 1.56000 | 44.4 |
| 7 | 10.863 | 0.949 | | |
| 8 | 13.277 | 2.800 | 1.84666 | 23.8 |
| 9 | 171.000 | 0.726 | | |
| 10 | −44.323 | 0.700 | 1.89000 | 46.8 |
| 11 | −161.869 | d11 | | |
| 12(Diaphragm) | ∞ | 0.100 | | |
| 13* | 11.023 | 3.000 | 1.61881 | 63.8 |
| 14* | −25.753 | 0.382 | | |
| 15 | 7.719 | 2.500 | 1.61000 | 83.0 |
| 16 | 18.388 | 1.500 | 2.00069 | 25.5 |
| 17 | 5.569 | 2.547 | | |
| 18 | 20.239 | 1.400 | 1.66000 | 43.3 |
| 19 | 223.372 | d19 | | |
| 20* | 20.937 | 2.500 | 1.54358 | 55.7 |
| 21* | −44.837 | d21 | | |
| 22 | ∞ | 2.000 | 1.51680 | 64.2 |
| 23 | ∞ | — | | |

The asterisk (*) designates an aspherical surface which is rotationally symmetrical with respect to the optical axis.

TABLE 14
ZOOM LENS SYSTEM DATA
Zoom Ratio 3.91

| | Short Focal Length | Intermediate | Long Focal Length |
|---|---|---|---|
| | Extremity | Focal Length | Extremity |
| FNO. | 1.9 | 2.6 | 2.8 |
| f | 6.21 | 11.30 | 24.31 |
| W | 41.4 | 22.1 | 10.6 |
| Y | 4.62 | 4.62 | 4.62 |
| fB | 0.10 | 0.10 | 0.10 |
| L | 64.61 | 67.84 | 72.06 |
| d3 | 0.176 | 9.502 | 19.277 |
| d11 | 21.836 | 13.015 | 2.209 |
| d19 | 5.247 | 8.095 | 8.001 |
| d21 | 0.481 | 0.358 | 5.712 |

TABLE 15
Aspherical Surface Data (the aspherical surface
coefficients not indicated are zero (0.00)):

| Surf. No. | K | A4 | A6 | A8 | A10 |
|---|---|---|---|---|---|
| 13 | −0.059 | −0.7948E−04 | −0.2759E−06 | −0.1973E−07 | |
| 14 | 0.000 | 0.7571E−04 | 0.6359E−06 | −0.4347E−07 | |
| 20 | 0.000 | −0.2518E−03 | −0.5854E−05 | 0.7614E−07 | −0.7350E−10 |
| 21 | 0.000 | −0.3019E−03 | −0.6102E−05 | 0.6461E−07 | 0.2836E−09 |

TABLE 16
LENS GROUP DATA

| Lens Group | 1^{st} Surf. | Focal Length |
|---|---|---|
| 1 | 1 | 62.65 |
| 2 | 4 | −10.65 |
| 3 | 13 | 13.00 |
| 4 | 20 | 26.61 |

The numerical values of each condition for each embodiment are shown in Table 17.

TABLE 17

| | Embod. 1 | Embod. 2 | Embod. 3 | Embod. 4 |
|---|---|---|---|---|
| Cond. (1) | 4.616 | 2.560 | 4.984 | 11.436 |
| Cond. (2) | 2.349 | 2.592 | 2.396 | 2.220 |
| Cond. (3) | 2.587 | 2.925 | 2.701 | 2.587 |
| Cond. (4) | 1.424 | 1.654 | 1.542 | 1.383 |
| Cond. (5) | 3.887 | 4.425 | 4.086 | 3.579 |
| Cond. (6) | −0.396 | −0.392 | −0.407 | −0.424 |
| Cond. (7) | 0.446 | 0.462 | 0.489 | 0.401 |
| Cond. (8) | −0.875 | −0.911 | −0.949 | −1.020 |
| Cond. (9) | −0.110 | −0.115 | −0.116 | −0.120 |

As can be understood from Table 17, the first through fourth numerical embodiments satisfy conditions (1) through (9). Furthermore, as can be understood from the aberration diagrams, the various aberrations are suitably corrected.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A zoom lens system comprising a positive first lens group, a negative second lens group, a positive third lens group and a fourth lens group, in that order from the object side,
wherein said third lens group includes at least two positive single lens elements,
wherein, with respect to the object side, one of a second or subsequently rearward positive single lens element of said at least two positive single lens elements constitutes an image-shake correcting lens element which corrects an image-shake by moving in directions orthogonal to the optical axis to change an imaging position, and
wherein the following conditions (1) and (2) are satisfied:
0<De<15 (1), and
2.0<1/((1−G3Rmt)Fmt)<3.0 (2), wherein
De designates the distance [mm] from the surface on the object side of said image-shake correcting lens element of said third lens group to the incident pupil, at the long focal length extremity when focused on an object at infinity,
G3Rmt designates the lateral magnification of said image-shake correcting lens element of said third lens group, at the long focal length extremity when focused on an object at infinity, and
Fmt designates the lateral magnification of a lens group immediately behind said image-shake correcting lens element, at the long focal length extremity when focused on an object at infinity.

2. The zoom lens system according to claim 1, wherein the following condition (3) is satisfied:
2.0<G3Rf/G3f<3.5 (3), wherein
G3Rf designates the focal length of said image-shake correcting lens element of said third lens group, and
G3f designates the focal length of said third lens group.

3. The zoom lens system according to claim 1, wherein the following condition (4) is satisfied:
1.0<Ft/G3Rf<2.0 (4), wherein
Ft designates the focal length of the entire zoom lens system at the long focal length extremity, and
G3Rf designates the focal length of said image-shake correcting lens element of said third lens group.

4. The zoom lens system according to claim 1, wherein the following condition (5) is satisfied:
3.0<1/((1−G3Rmw)Fmw)<5.0 (5), wherein
G3Rmw designates the lateral magnification of said image-shake correcting lens element of said third lens group, at the short focal length extremity when focused on an object at infinity, and
Fmw designates the lateral magnification of a lens group immediately behind said image-shake correcting lens element, at the short focal length extremity when focused on an object at infinity.

5. The zoom lens system according to claim 1, wherein said third lens group comprises a positive single lens element, a negative cemented lens provided with a positive lens element and a negative lens element; and a positive single lens element, in that order from the object side,
wherein the positive single lens element provided closest to the image side within said third lens group is said image-shake correcting lens element.

6. The zoom lens system according to claim 5, wherein the following conditions (6) and (7) are satisfied:
−0.5<G3Fmw<−0.15 (6), and
0.35<(R2+R1)/(R2−R1)<0.65 (7), wherein
G3Fmw designates the lateral magnification of the positive single lens element that is provided on the object side within said third lens group, at the short focal length extremity;
R2 designates the radius of curvature of the surface on the image side of the positive single lens element on the object side within said third lens group, and
R1 designates the radius of curvature of the surface on the object side of the positive single lens element on the object side within said third lens group.

7. The zoom lens system according to claim 5, wherein the following condition (8) is satisfied:
−1.5<G3Fmt<−0.4 (8), wherein
G3Fmt designates the lateral magnification of the positive single lens element that is provided on the object side within said third lens group, at the long focal length extremity.

8. The zoom lens system according to claim 5, wherein the following condition (9) is satisfied:
−0.25<φ/(n2−n1)<−0.05 (9), wherein
φ designates the combined refractive power of said cemented lens within said third lens group,
n2 designates the refractive index at the d-line of the negative lens element provided in said cemented lens within said third lens group, and
n1 designates the refractive index at the d-line of the positive lens element provided in said cemented lens within said third lens group.

9. A zoom lens system comprising a positive first lens group, a negative second lens group, a positive third lens group and a fourth lens group, in that order from the object side,
wherein said third lens group is divided into a positive front lens group and a positive rear lens group at a maximum air-distance therebetween, in that order from the object side,
wherein said rear lens group is a image-shake correcting lens group which corrects image-shake by moving in directions orthogonal to the optical axis, thereby changing the imaging position, and
wherein the following conditions (1′) and (2′) are satisfied:
0<De′<15 (1′), and
2.0<1/((1−G3Rmt′)Fmt′)<3.0 (2′), wherein
De′ designates the distance [mm] from the surface on the object side of said image-shake correcting lens group of said third lens group to the incident pupil, at the long focal length extremity when focused on an object at infinity,
G3Rmt′ designates the lateral magnification of said image-shake correcting lens group of said third lens group, at the long focal length extremity when focused on an object at infinity, and
Fmt′ designates the lateral magnification of a lens group immediately behind said image-shake correcting lens group, at the long focal length extremity when focused on an object at infinity.

10. The zoom lens system according to claim 9, wherein said image-shake correcting lens group of said third lens group comprises a positive single lens element.
